(19) United States
(12) Patent Application Publication
(10) Pub. No.: US 2010/0214272 A1
(43) Pub. Date: Aug. 26, 2010

(54) DISPLAY AND ELECTRONIC APPARATUS EQUIPPED WITH SAME

(75) Inventor: Hirofumi Watsuda, Kobe (JP)

Correspondence Address: LIU & LIU, 444 S. FLOWER STREET, SUITE 1750, LOS ANGELES, CA, 90071, US

(73) Assignee: TPO Displays Corp., Chu-Nan (TW)

(21) Appl. No.: 12/707,635

(22) Filed: Feb. 17, 2010

(30) Foreign Application Priority Data
Feb. 23, 2009 (JP) 2009-038757

(51) Int. Cl. G06F 3/038; G09G 3/36

(52) U.S. Cl. 345/205; 345/90; 345/212

(57) ABSTRACT

An active matrix display capable of compensating leaking current while maintaining the aperture rate is provided. The active matrix display device has a plurality of pixels arranged as a matrix, and each of the pixels includes a liquid crystal display element; a driving control switch for controlling the driving of the liquid crystal display element; and a storage capacitor for storing image data provided to the liquid crystal display element via the driving control switch. The display device is an active matrix display device comprising voltage-compensating means for applying a specified voltage to one end of the storage capacitor opposite to another end coupled to the liquid crystal display element in a maintaining period.

### FIELD OF THE INVENTION

The present invention relates to an active matrix display including a plurality of pixels arranged as a matrix, and an electronic apparatus equipped with such a display.

### BACKGROUND OF THE INVENTION

In general, in an active matrix display utilizing liquid crystal display elements, each pixel is disposed with a switch for controlling the writing of image data into the liquid crystal display elements and a storage capacitor for storing data within a writing and switching period of the image data. However, the image data held as charges in the capacitor is subject to loss with time due to leaking current. The leaking current causes reduction in a pixel voltage and renders flicker.

For example, the PCT Japanese Patent Publication No. 2004-518993 discloses a technique for reducing leaking current from a storage capacitor.

In the prior art, the effect of leaking current is compensated by enlarging the capacity of the storage capacitor or inserting an amplifying circuit between the storage capacitor and the liquid crystal display element. Then a problem of reduced pixel aperture rate may be encountered. Take a transmissive LCD with a backlight source for illumination from the back side as an example. Once the pixel aperture rate is reduced, the illuminance of the backlight source needs to be higher, and thus power consumption is increased.

In view of the problem encounter in the prior art, an object of the present invention is to provide an active matrix display capable of compensating leaking current while maintaining the aperture rate and an electronic apparatus equipped with such a display.

### SUMMARY OF THE INVENTION

In order to achieve the object mentioned above, there is provided an active matrix display device having a plurality of pixels arranged as a matrix, each of the pixels comprising: a liquid crystal display element; a driving control switch for controlling the driving of the liquid crystal display element; and a storage capacitor for storing image data provided to the liquid crystal display element via the driving control switch. The display device is an active matrix display device comprising voltage-compensating means for applying a specified voltage to one end of the storage capacitor opposite to another end coupled to the liquid crystal display element in a maintaining period.

In this way, the leaking current problem occurring in the maintaining period can be remedied, and the flicker problem can be ameliorated. Furthermore, according to this example, since there is no modification in the pixel structure, a pixel aperture rate comparable to prior art can be kept.

In an embodiment of the invention, the voltage-compensating means has the specified voltage change at multiple levels in the maintaining period according to previously programmed voltage steps. Preferably, the voltage-compensating means has the specified voltage linearly change in the maintaining period.

In this way, optimal compensating operations for leaking current can be determined depending on uses and ambient conditions of the display device, implementation of the switch element as the driving control switch, and the function of the controller.

In an embodiment of the invention, the voltage-compensating means applies the specified voltage to the storage capacitor via the CS lines.

In this way, the structure is simplified as existent CS lines are used. Nevertheless, it is required in this embodiment that the CS lines are independent for different rows.

In an embodiment of the invention, the voltage-compensating means includes: a voltage source for providing the specified voltage; a voltage-step storing member for storing previously programmed voltage steps; and a power control member for controlling the voltage source in order to having the specified voltage change at multiple levels in the maintaining period according to previously programmed voltage steps.

According to an embodiment of the present invention, the active matrix display device can be used in an electronic apparatus equipped with a display device for prompting users. Examples include a laptop PC, mobile phone, portable personal digital assistant (PDA), car navigation device or portable game set.

According to the present invention, it is able to provide an active matrix display capable of compensating leaking current while maintaining the aperture rate and an electronic apparatus equipped with such a display.

### BRIEF DESCRIPTION OF THE DRAWINGS

FIG. 1 illustrates an example of an electronic apparatus equipped with a display device according to an embodiment of the present invention.

FIG. 2 illustrates construction of a display device according to an embodiment of the present invention.

FIG. 3 illustrates construction of a pixel according to an embodiment of the present invention.

FIG. 4 illustrates construction of a voltage-compensating member according to an embodiment of the present invention.

FIG. 5A is a timing chart illustrating a first example of compensating operation for leaking current by a voltage-compensating member according to an embodiment of the present invention.

FIG. 5B is a timing chart illustrating a second example of compensating operation for leaking current by a voltage-compensating member according to an embodiment of the present invention.

### DETAILED DESCRIPTION OF THE PREFERRED EMBODIMENT

Hereinafter, embodiments according to the present invention are described with reference to the accompanying drawings.

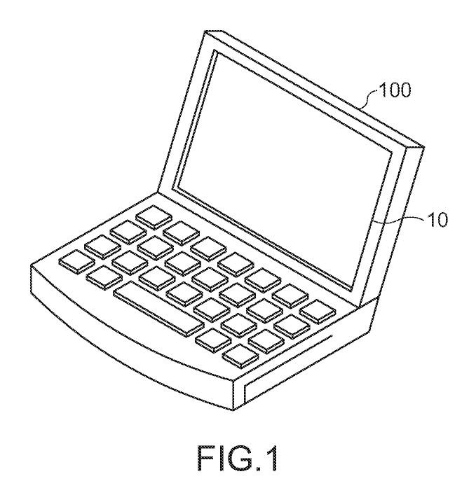

FIG. 1 illustrates an example of an electronic apparatus equipped with a display device according to an embodiment of the present invention. The electronic apparatus 100 as shown in FIG. 1 is a laptop PC. Alternatively, it can also be another electronic apparatus, e.g. a mobile phone, portable personal digital assistant (PDA), car navigation device or portable game set. The electronic apparatus 100 has a display device 10 which includes a display module for displaying images, etc.

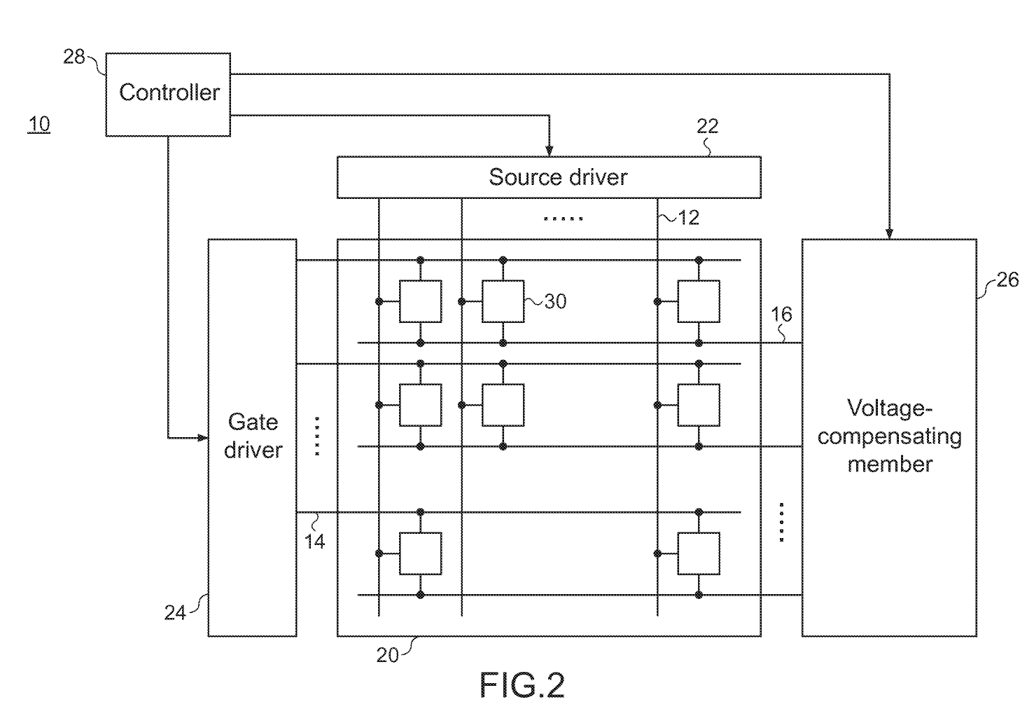

FIG. 2 illustrates construction of a display device according to an embodiment of the present invention. The display device 10 as shown in FIG. 2 includes a display module 20, a source drive 22, a gate driver 24, a voltage-compensating member 26 and a controller 28.

In the display module 20, at least one liquid crystal display element is disposed at an intersect of a source line 12 and a gate line 14. The source driver 22 is connected to each of the pixels though the source line 12 for providing image data to the pixels. The gate driver 24 controls ON/OFF of each pixel via the gate line 14. The voltage-compensating member 26 is connected to each of the pixels through a voltage-compensating line 16 for providing an offset voltage for each pixel for leaking current compensation. The controller 28 synchronizes the source driver 22, gate deriver 24 and voltage-compensating member 26, and controls their operations.

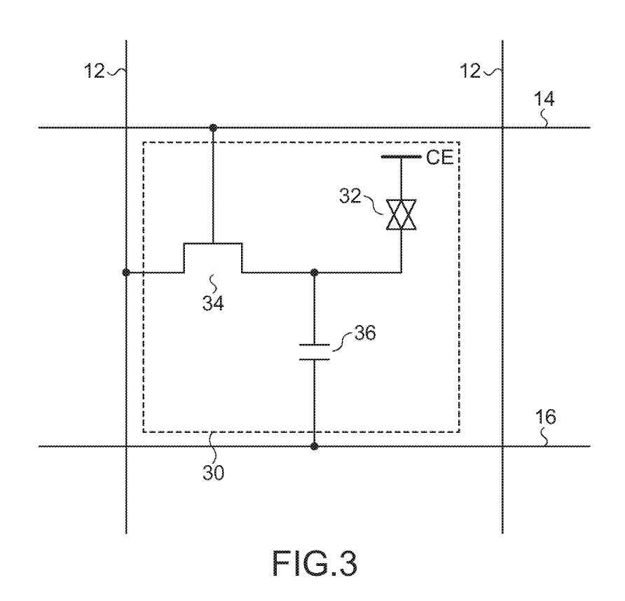

FIG. 3 illustrates construction of a pixel according to an embodiment of the present invention. The pixel 30 as shown in FIG. 3 is disposed with a liquid crystal display element 32, a driving control switch 34 for controlling the driving of the liquid crystal display element 32, and a storage capacitor 36 for storing image data provided to the liquid crystal display element 32 via the driving control switch 34.

The liquid crystal display element 32 has one end coupled to a common electrode CE, and another end coupled to the source line 12 via the driving control switch 34. The driving control switch 34, e.g. a thin film transistor (TFT), connects the control terminal to the gate line 14. When the gate line 14 is at a high level, the driving control switch 34 is switched on so as to apply a voltage of the source line 12 to the liquid crystal display element 32.

The storage capacitor 36 has one end coupled to the connection of the liquid crystal display element 32 and the driving control switch 34, and another end coupled to the voltage-compensating line 16. In this embodiment, a CS line coupled to the storage capacitor 36 in a general pixel structure may be used as the voltage-compensating line 16. However, in this embodiment, CS lines in different rows should be independent. When the gate line 14 is at a low level and during the driving control switch is switched off, the storage capacitor 36 maintains the voltage applied to the liquid crystal display element 32 via the driving control switch 34 in the form of charges. Actually, charges stored in the storage capacitor 36 would be subject to loss with time as leaking current flowing to the source line 12 via the driving control switch 34. In order to compensate the leaking current, a specified voltage is applied to the storage capacitor 36 via the voltage-compensating line 16 by the voltage-compensating member 26 in the voltage-maintaining period. Concretely, by way of capacity coupling to the storage capacitor 36, the potential level at the connection of the liquid crystal display element 32 and the driving control switch 34, accurately at the end of the liquid crystal display element 32 opposite to the end coupled to the common electrode, is shifted so as to compensate the leaking current.

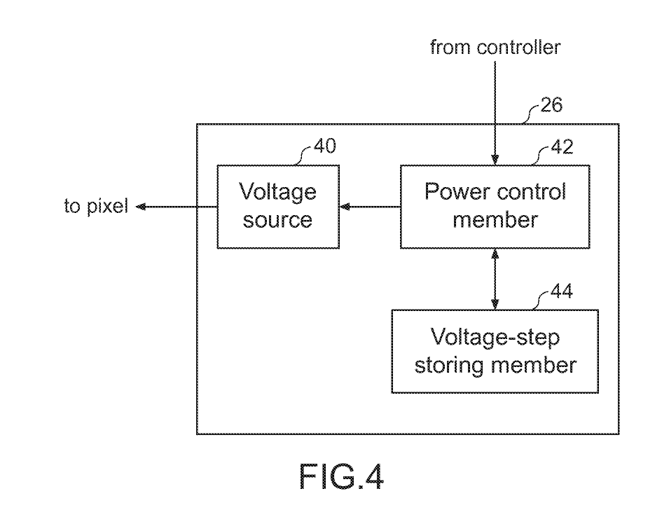

FIG. 4 illustrates construction of a voltage-compensating member according to an embodiment of the present invention. The voltage-compensating member 26 shown in FIG. 4 includes a voltage source 40 for providing a specified voltage to each of the pixels via the voltage-compensating line 16, a power control member 42 for controlling the voltage source 40 according to a control signal from the controller 28, and a voltage-step storing member 44 for storing previously programmed voltage steps.

The voltage source 40 is a variable voltage source capable of changing voltages with multi-levels or linearly. The power control member 42 receives from the controller 28 a control signal that indicates that an offset voltage is to be provided for pixels in the voltage-maintaining period, and has the voltage supplied from the voltage source 40 changed according to a previously programmed voltage step stored in the voltage-step storing member 44.

The voltage steps are set when the display device 10 is made according to uses and ambient conditions of the display device 10, implementation of the switch element as the driving control switch 34, and the function of the power control member 42. Hereinafter, the compensating operations for leaking current by the voltage-compensating member 26 will be described according to a variety of voltage steps.

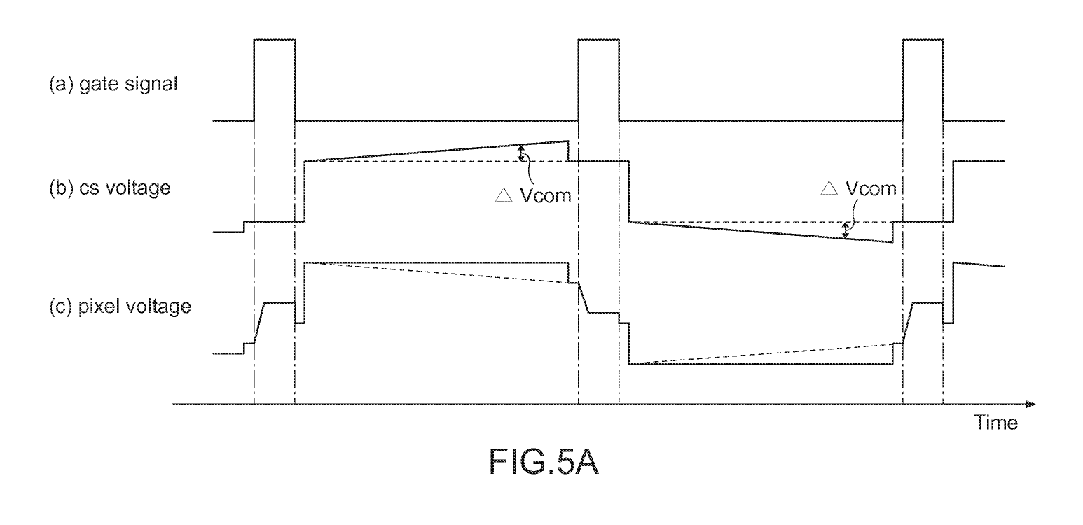

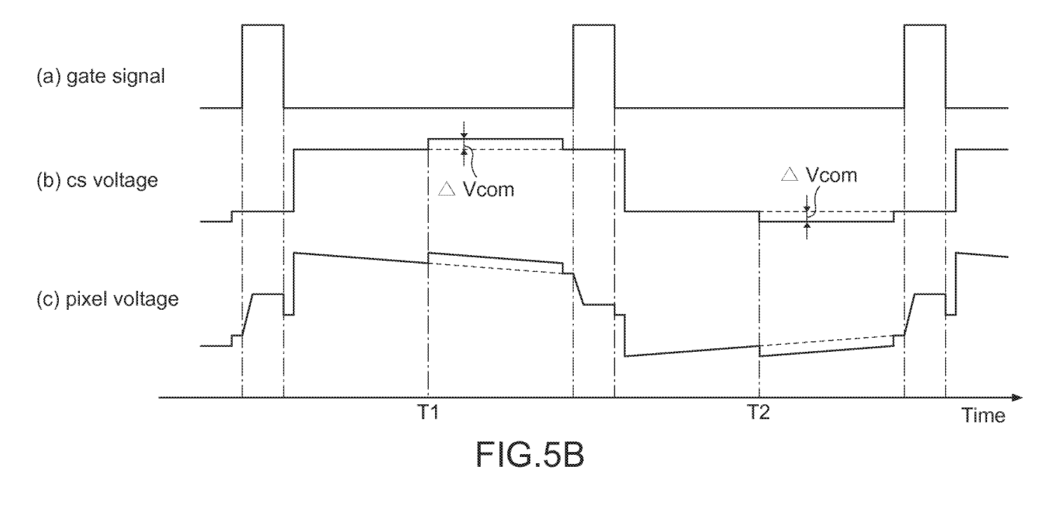

FIG. 5A is a timing chart illustrating a first example of compensating operation for leaking current by a voltage-compensating member according to an embodiment of the present invention. In FIG. 5A, changes of a gate signal (a), a CS voltage (b) and a pixel voltage (c) with time are shown sequentially.

The gate signal is a signal provided from the gate driver 24 to the control terminal of the driving control switch 34 of the pixel 30 via the gate line 14. In this embodiment, the high level of the gate signal renders the ON state of the driving control switch 34. Once the driving control switch 34 is switched on, a voltage indicative of image data provided from the source driver 22 via the source line 12 is applied to the liquid crystal display element 32.

The CS voltage is a voltage provided from the voltage-compensating member 26 to the storage capacitor of the pixel 30 via the voltage-compensating line 16 (i.e. the CS line in this embodiment). According to prior art, when the gate signal is at a low level and during the off period of the driving control switch 34 (i.e. the voltage-maintaining period), the CS voltage is constant as indicated by the dashed line in the drawing. In contrast, according to this embodiment, the CS voltage in the voltage-maintaining period, as indicated by the solid line in the drawing, linearly increases or decreases with a specified slope.

The pixel voltage is a voltage at the connection of the liquid crystal display element 32 and the driving control switch 34, accurately at the end of the liquid crystal display element 32 opposite to the end coupled to the common electrode. The voltage is stored in the storage capacitor 36 in the form of charges in the voltage-maintaining period. According to prior art, charges stored in the storage capacitor 36 would be subject to loss with time as leaking current flowing to the source line 12 via the driving control switch 34. Therefore, the pixel voltage would decay as indicated by the dash lines in the drawing. In contrast, according to this embodiment, the pixel voltage will not decay, and instead, is kept constant, as indicated by the solid lines in the drawing. It results from a specified voltage ΔV_{com}, linearly increasing or decreasing with a specified slope, which is applied to one end of the storage capacitor 36 opposite to the end coupled to the liquid crystal display element 32.

FIG. 5B is a timing chart illustrating a second example of compensating operation for leaking current by a voltage-compensating member according to an embodiment of the present invention. In FIG. 5B, changes of a gate signal (a), a CS voltage (b) and a pixel voltage (c) with time are shown sequentially.

In this example, the CS voltage, as indicated by the solid line in the drawing, changes to another constant value at specified time points (T1 and T2) in the voltage-maintaining period. Accordingly, the pixel voltage, as indicated by the solid line in the drawing, will decay with leaking current prior to the specified time points (T1 and T2) in the voltage-maintaining period, just like the prior art. However, once the specified time points are reached, only increase or decrease amount equivalent to the variation amount ΔV_{com}, of the CS voltage for compensating the decay is involved.

In this way, the voltage-compensating member 26 according to an embodiment of the present invention applies a constant voltage to the end of the storage capacitor 36 opposite to the end coupled to the liquid crystal display element 32, thereby compensating the pixel voltage drop rendered by leaking current. As a result, the flicker problem caused by pixel voltage drop can be avoided. Furthermore, according to this example, there is no modification in the pixel structure so as to maintain the pixel aperture rate.

The invention is described as above based on preferred embodiments, but is not limited to the embodiments as described. Instead, modification or change may be made within the scope of the invention.

For example, the voltage-compensating member 26 in the above embodiments receives a control signal from the controller 28 and feeds an offset voltage to each pixel according to previously programmed voltage steps. Alternatively, the voltage-compensating member 26 may be configured to be able to directly receive a signal indicating a high/low state of the gate signal from the gate driver 24.

Furthermore, although the voltage-compensating lines 16 in the above embodiments are disposed in each row of the pixel matrix, the voltage-compensating lines 16 can also be disposed in each column or each pixel instead of in each row, depending on the driving mode of the display device, e.g. dot inversion driving, horizontal or vertical inversion driving or frame inversion driving.

1. An active matrix display device having a plurality of pixels arranged as a matrix, each of the pixels comprising:
a liquid crystal display element;
a driving control switch for controlling the driving of the liquid crystal display element; and
a storage capacitor for storing image data provided to the liquid crystal display element via the driving control switch;
wherein the display device is an active matrix display device comprising voltage-compensating means for applying a specified voltage to one end of the storage capacitor opposite to another end coupled to the liquid crystal display element in a maintaining period.

2. The active matrix display device according to claim 1 wherein the voltage-compensating means has the specified voltage change at multiple levels in the maintaining period according to previously programmed voltage steps.

3. The active matrix display device according to claim 2 wherein the voltage-compensating means has the specified voltage linearly change in the maintaining period.

4. The active matrix display device according to claim 1 wherein the voltage-compensating means applies the specified voltage to the storage capacitor via the CS lines.

5. The active matrix display device according to claim 1 wherein the voltage-compensating means includes:
a voltage source for providing the specified voltage;
a voltage-step storing member for storing previously programmed voltage steps; and
a power control member for controlling the voltage source in order to having the specified voltage change at multiple levels in the maintaining period according to previously programmed voltage steps.

6. An electronic apparatus comprising an active matrix display device as recited in claim 1.

7. An electronic apparatus comprising an active matrix display device as recited in claim 2.

8. An electronic apparatus comprising an active matrix display device as recited in claim 3.

9. An electronic apparatus comprising an active matrix display device as recited in claim 4.

10. An electronic apparatus comprising an active matrix display device as recited in claim 5.
